(19) United States
(12) Patent Application Publication
(10) Pub. No.: US 2006/0195638 A1
(43) Pub. Date: Aug. 31, 2006

(54) Peripheral device

(75) Inventor: Susumu Yamazaki, Musashimurayama-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Toshiba America Information Systems, Inc.

(21) Appl. No.: 11/345,140

(22) Filed: Feb. 1, 2006

(30) Foreign Application Priority Data
Feb. 28, 2005 (JP) 2005-053332

(51) Int. Cl. G06F 13/42

(52) U.S. Cl. 710/106

(57) ABSTRACT

According to one embodiment, a peripheral device including a bus controller which controls input of transmission data from a host system via a bus and output of reception data to the host system via the bus, a communication controller which receives the transmission data from the bus controller to transfer the transmission data to the another system, and receives the reception data from the another system to transfer the reception data to the bus controller, and a clock control circuit which divides clock supply for the bus controller and controls the clock supply in order to stop the clock supply to a portion for a data reception process in the bus controller in a period of time other than a time for the reception operation performed by the communication controller, while the clock is kept supplied to a portion for a data transmission process in the bus controller.

### CROSS-REFERENCE TO RELATED APPLICATIONS

This application is based upon and claims the benefit of priority from Japanese Patent Application No. 2005-053332, filed Feb. 28, 2005, the entire contents of which are incorporated herein by reference.

### BACKGROUND

1. Field

One embodiment of the invention relates to a power saving control technique suitably used for, e.g., a wireless communication PCI device and the like incorporated in a personal computer which can be wirelessly connected to a network via an access point.

2. Description of the Related Art

In recent years, a battery-powered and portable personal computer such as a notebook-type personal computer has become very popular. Most personal computers of this type have a wireless communication function capable of wirelessly connecting to a network via an access point. By using such a personal computer having the wireless communication function, data can be transmitted/received anywhere as long as an access point is present. Therefore, various operations can be conveniently done away from home.

The wireless communication function is generally implemented using, e.g., a PCI device incorporated as a peripheral device in the personal computer. Since all operation power of the personal computer is supplied by a battery while the user is away from home, the peripheral device such as the wireless communication PCI device requires various power saving functions.

Accordingly, for example, it has been proposed to divide an interface which manages connection between a PCI bus and the peripheral device into a plurality of blocks, and limit the supply of an operation clock to an unused block, thus reducing power consumption (e.g., see Jpn. Pat. Appln. KOKAI Publication No. 2004-234269).

In the scheme disclosed in Jpn. Pat. Appln. KOKAI Publication No. 2004-234269, the internal circuit of the interface interposed between the PCI bus and the peripheral device is divided, and the clock supply is individually controlled for each divided internal circuit. Accordingly, this effect is limited within the interface. Therefore, the wireless communication PCI device which must always be ready for an access from a host system requires, as a whole, delicate clock control in accordance with its operation state.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing an arrangement of an electronic apparatus according to an embodiment of the invention;

FIG. 2 is a flowchart showing an exemplary transmission procedure of a PCI device incorporated in the electronic apparatus according to the embodiment;

FIG. 3 is a flowchart showing an exemplary reception procedure of the PCI device incorporated in the electronic apparatus according to the embodiment; and

FIG. 4 is an exemplary block diagram showing a modification of the PCI device incorporated in the electronic apparatus according to the embodiment.

### DETAILED DESCRIPTION

Various embodiments according to the invention will be described hereinafter with reference to the accompanying drawings. In general, according to one embodiment of the invention, a peripheral device including a bus controller which controls input of transmission data from a host system via a bus and output of reception data to the host system via the bus, a communication controller which receives the transmission data from the bus controller to transfer the transmission data to the another system, and receives the reception data from the another system to transfer the reception data to the bus controller, and a clock control circuit which divides clock supply for the bus controller and controls the clock supply in order to stop the clock supply to a portion for a data reception process in the bus controller in a period of time other than a time for the reception operation performed by the communication controller, while the clock is kept supplied to a portion for a data transmission process in the bus controller.

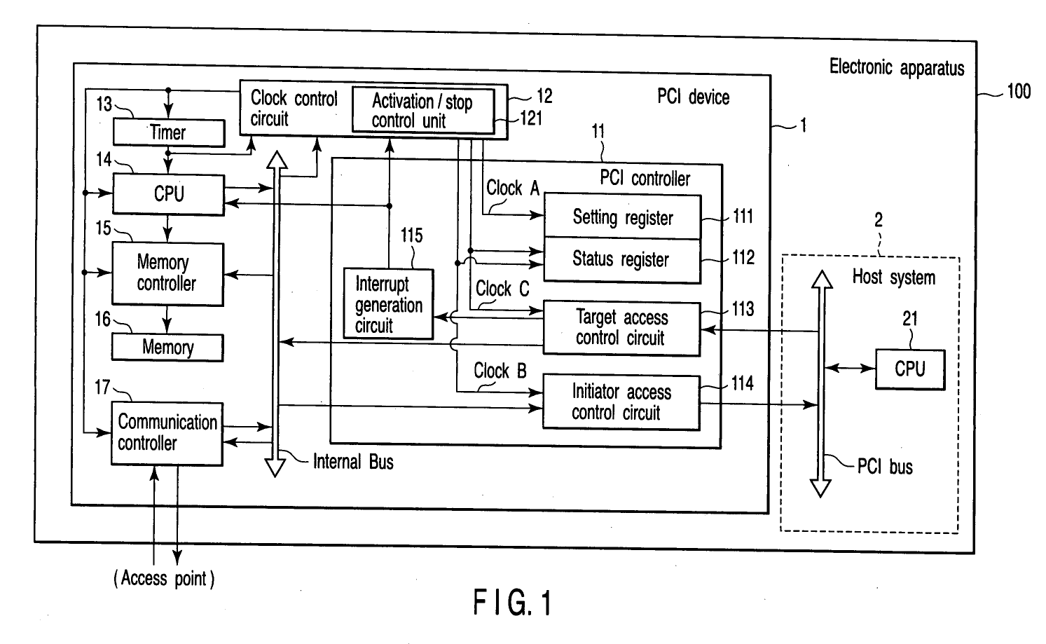

FIG. 1 is a block diagram showing an arrangement of an electronic apparatus according to the embodiment of the present invention. An electronic apparatus 100 is a personal computer in which a PCI bus is used as a system bus. In this embodiment, a peripheral device of the present invention is implemented as a PCI device 1.

In order to transmit/receive data to/from another electronic apparatus via an IEEE 802.11 wireless LAN, the electronic apparatus 100 has a function of accessing an access point which manages the network, and the PCI device 1 accesses the access point under the control of a host system 2. The host system 2 includes a CPU 21 for controlling the overall operation in the electronic apparatus 100.

That is, the PCI device 1 has the following functions as a communication device with a PCI interface. Upon reception of transmission data from the host system 2 via the PCI bus, the PCI device 1 transmits this transmission data to the access point, and confirms presence/absence of reception data by accessing the access point every predetermined interval. If the reception data is present, the PCI device 1 receives this reception data, and outputs it to the host system 2 via the PCI bus.

Note that an operation of sending data from the electronic apparatus 100 to the access point is called a transmission operation, and an operation of causing the electronic apparatus 100 to receive data from the access point is called a reception operation. That is, the operation of receiving the data from the host system 2 with respect to the PCI device 1 is called the transmission operation, and the operation of transmitting the data to the host system 2 with respect to the PCI device 1 is called the reception operation.

As shown in FIG. 1, the PCI device 1 includes a PCI controller 11, clock control circuit 12, timer 13, CPU 14, memory controller 15, memory 16, and communication controller 17.

The PCI controller 11 controls input/output of the data to/from the PCI bus in order to transmit/receive the data to/from the host system 2. As shown in FIG. 1, the PCI controller 11 includes a setting register 111, status register 112, target access control circuit 113, initiator access control circuit 114, and interrupt generation circuit 115.

The setting register 111 is a register for storing setting information indicating how to operate the PCI device 1. The status register 112 is a register for storing status information indicating the state of the PCI device 1. The target access control circuit 113 is a circuit for receiving the transmission data from the host system 2 via the PCI bus. The initiator access control circuit 114 is a circuit for outputting the reception data to the host system 2 via the PCI bus. The interrupt generation circuit 115 is a circuit for supplying, when the target access control circuit 113 receives the transmission data from the host system 2, an interrupt signal for notifying the clock control circuit 12 and the CPU 14 of an interrupt.

An operation clock of each unit such as the PCI controller 11 in the PCI device 1 is supplied by the clock control circuit 12. The clocks supplied from the clock control circuit 12 to the PCI controller 11 are divided into three systems, i.e., a clock A supplied to a portion for a setting process, a clock B supplied to a portion for a reception process, and a clock C supplied to a portion for a transmission process. In order to individually control these three clocks, the clock control circuit 12 includes an activation/stop control unit 121. That is, first, the PCI device 1 according to the embodiment divides the clock of the PCI controller 11 into the plurality of systems, and stops some of the clocks other than the portions which require the clock, by using the activation/stop control unit 121. Accordingly, power consumption can be reduced.

More specifically, clock A is supplied to the setting register 111, clock B is supplied to the status register 112 and the initiator access control circuit 114, and clock C is supplied to the status register 112 and the target access control circuit 113. Upon activation of the PCI device 1, the activation/stop control unit 121 starts supplying all of clocks A, B, and C. After that, upon completion of initial setting, the activation/stop control unit 121 stops supplying clocks A and B excluding clock C to be supplied to the target access control circuit 113 to be in a state wherein the transmission data from the host system 2 can always be received, and the status register 112 to be in a state wherein the operation state of the target access control circuit 113 can be kept held. The timing of restarting the supply of clock B to the initiator access control circuit 114 will be described below.

he PCI controller 11 includes the interrupt generation circuit 115 for notifying that the target access control circuit 113 has received the transmission data from the host system 2. When no transmission data has been received, second, the PCI device 1 according to the embodiment stops the main part other than the PCI controller 11, thus reducing power consumption. The data transmission processing procedure of the PCI device 1 will now be described.

Assume that the supply of the clocks to the CPU 14, memory controller 15, and communication controller 17 is kept stopped by the clock control circuit 12, and that only clock C is kept supplied to the PCI controller 11. When the target access control circuit 113 which operates in response to clock C receives the transmission data, the interrupt generation circuit 115 generates the interrupt signal. Upon reception of this interrupt signal, the clock control circuit 12 starts supplying the clocks to the units such as the CPU 14. Upon reception of the clock, the CPU 14 receives the interrupt signal from the interrupt generation circuit 115, and detects input of the transmission data. The CPU 14 then drives and controls the memory controller 15 and the communication controller 17 so as to transmit the transmission data to the access point. More specifically, the CPU 14 receives the transmission data from the target access control circuit 113 via the internal bus, and buffers the transmission data in the memory 16. The CPU 14 then drives and controls the memory controller 15 and the communication controller 17 so as to transmit the transmission data buffered in the memory 16 to the access point. When a series of transmission operations pertaining to the transmission data are completed, the CPU 14 notifies the clock control circuit 12 that the CPU 14 itself can be stopped. Upon reception of this notification, the clock control circuit 12 stops supplying the clock to the unit such as the CPU 14.

The timer 13 is a circuit which generates an interrupt signal and supplies the generated interrupt signal to the clock control circuit 12 and the CPU 14 every predetermined interval. This predetermined interval is an interval to check whether the reception data to be supplied to the electronic apparatus 100 is held in the access point. By using the timer 13, in the PCI device 1 according to the embodiment, third, the main part other than the PCI controller 11 is stopped for a period of time other than the time for checking the reception data. When no reception data is present as a result of this check, the supply of clock B in the PCI controller 11 is kept stopped, thus reducing power consumption. The data reception processing procedure of the PCI device 1 will be described below.

Assume that the supply of the clocks to the CPU 14, memory controller 15, and communication controller 17 is kept stopped by the clock control circuit 12, and that only the clock to the timer 13 and clock C to the PCI controller 11 are kept supplied. When the timer 13 generates an interrupt signal, the clock control circuit 12 receives this interrupt signal from the timer 13, and then starts supplying the clock to the unit such as the CPU 14. Upon reception of the clock, the CPU 14 receives the interrupt signal from the timer 13, and detects that a timing for checking the presence/absence of the reception data has come. After that, the CPU 14 drives and controls the memory controller 15 and the communication controller 17 so as to receive the reception data with the check result from the access point. More specifically, the CPU 14 checks whether the reception data to be supplied to the electronic apparatus 100 is held in the access point. If the reception data is held in the access point, the CPU 14 drives and controls the memory controller 15 and the communication controller 17 so as to receive the reception data from the access point and buffer the reception data in the memory 16.

When the access point holds the reception data, and this reception data is received, the communication controller 17 notifies the clock control circuit 12 of the data reception. Upon reception of this notification, the clock control circuit 12 starts supplying clock B to the PCI controller 11. Accordingly, the initiator access control circuit 114 can transmit/receive the reception data. The memory controller 15 transfers the reception data buffered in the memory 16 to the initiator access control circuit 114 via the internal bus, and the initiator access control circuit 114 outputs this reception data to the PCI bus in the host system 2.

Upon completion of the series of reception operations of the reception data, the CPU 14 notifies the clock control circuit 12 that the CPU 14 itself can be stopped. Upon reception of this notification, the clock control circuit 12 stops supplying the clock to the unit such as the CPU 14. In this case, the clock control circuit 12 also stops supplying clock B to the PCI controller 11.

As described above, the PCI device 1 according to this embodiment can independently execute flexible clock control in accordance with the operation state at that time. That is, the PCI device 1 (1) divides the clocks of the PCI controller 11 into the plurality of systems, and stops some of clocks other than the portions which require the clock, by using the activation/stop control unit 121, (2) stops the main part other than the PCI controller 11 when no transmission data is received, and (3) stops the main part other than the PCI controller 11 for a period of time other than the time for checking the reception data, and keeps the stop state of clock B of the PCI controller 11 when no reception data is present as the check result.

Upon reception of an instruction to stop data transmission/reception between the host system 2 and the access point, the supply of clock C to the portion for the transmission process, i.e., the clock to the target access control circuit 113 to be in a state wherein the transmission data from the host system 2 can always be received is also stopped.

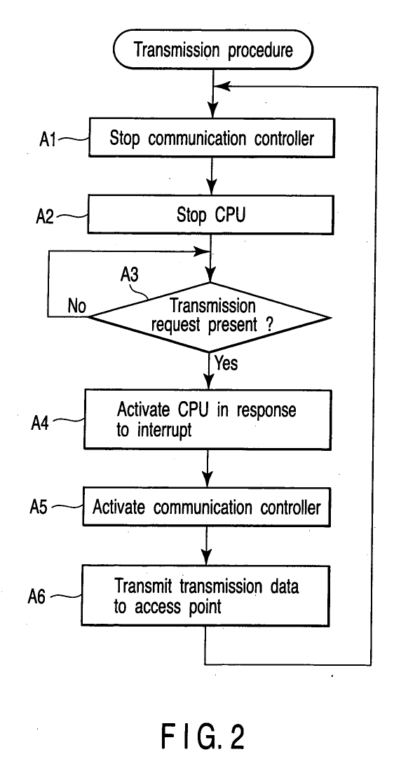

FIG. 2 is a flowchart showing a transmission procedure of the PCI device 1.

In the data transmission operation, the PCI device 1 defines the stop state of the communication controller 17 and the CPU 14 as an initial state. Hence, in the transmission procedure, first, the communication controller 17 and the CPU 14 are stopped (steps A1 and A2).

After that, when the target access control circuit 113 receives the transmission data (YES in step A3), the CPU 14 is activated in response to an interrupt signal generated by the interrupt generation circuit 115 (step A4). Sequentially, the communication controller 17 is activated by the CPU 14 (step A5). The activated communication controller 17 transmits the transmission data which is received by the target access control circuit 113, to the access point (step A6).

Upon completion of the transmission process to the access point, the communication controller 17 and the CPU 14 are stopped again as in steps A1 and A2 to return to the initial state. In step A3, the transmission data from the target access control circuit 113 is awaited.

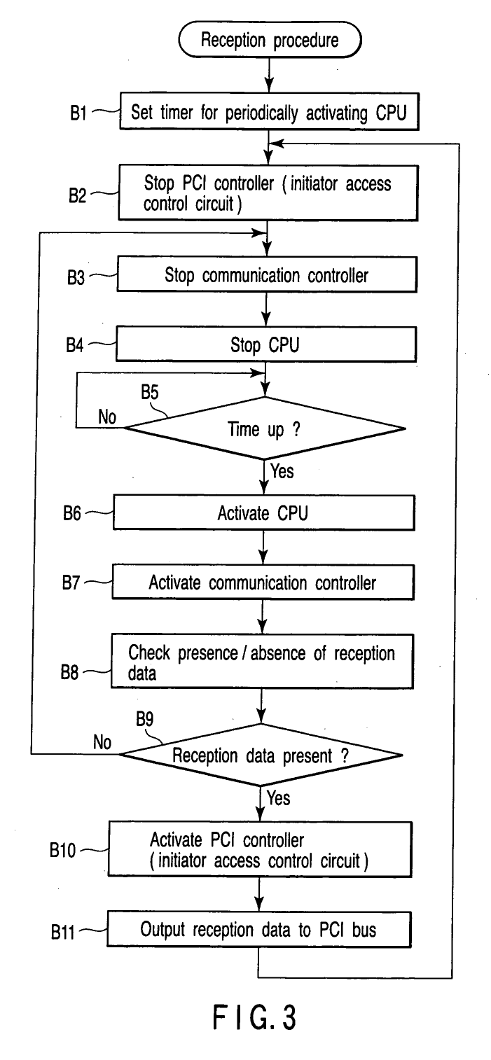

FIG. 3 is a flowchart showing the reception procedure of the PCI device 1.

In the data reception operation, the PCI device 1 defines the stop state of the initiator access control circuit 114 in the PCI controller 11, and the communication controller 17 and the CPU 14 as an initial state. The PCI device 1 sets the timer 13 in order to periodically activate the CPU (step B1). The PCI device 1 then stops the initiator access control circuit 114 in the PCI controller 11 (step B2), and the communication controller 17 and the CPU 14 (steps B3 and B4).

After that, when time up occurs (YES in step B5), the CPU 14 is activated in response to an interrupt signal generated by the timer 13 (step B6). The communication controller 17 is then activated by the CPU 14 (step B7). The activated communication controller 17 receives the reception data containing a check result, from the access point (step B8). If the reception data is present (YES in step B9), the initiator access control circuit 114 in the PCI controller 11 is activated (step B10) to output the reception data to the PCI bus in the host system 2 (step B11).

Upon completion of the reception process from the access point, when the reception data is present, the initiator access control circuit 114 in the PCI controller 11 is stopped again as in step B2, and the communication controller 17 and the CPU 14 are stopped again as in steps B3 and B4. If no reception data is present, i.e., if the initiator access control circuit 114 in the PCI controller 11 is not activated in step B10, only the communication controller 17 and the CPU 14 are stopped again as in steps B3 and B4 to return to the initial state. In step B5, the next time up is awaited.

As described above, the PCI device 1 of the embodiment voluntarily executes flexible clock control in accordance with the operation state at that time.

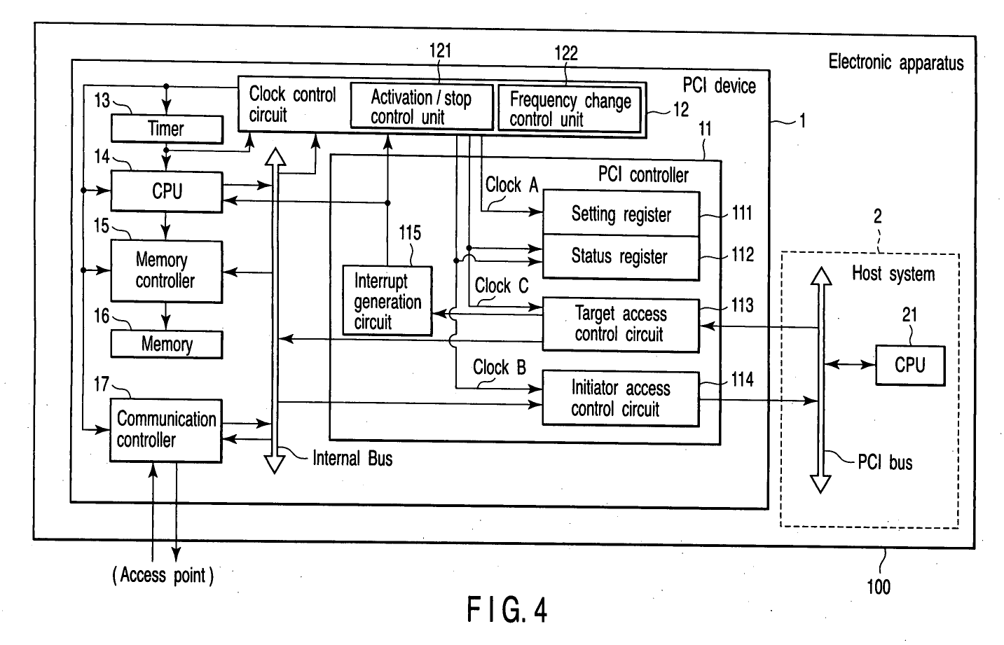

In this embodiment, some of the clocks other than the units which require the clock are stopped by the activation/stop control unit 121 in the clock control circuit 12. However, the clock may not be stopped depending on the system configuration. In this case, as shown in FIG. 4, a frequency change control unit 122 may be juxtaposed to the clock control circuit 12. By using the frequency change control unit 122, an unstoppable clock is not stopped by the activation/stop control unit 121, but the clock frequency of the unstoppable clock can be reduced by the frequency change control unit 122 to reduce power consumption. For example, when reducing the frequency to 1/10, power consumption can be reduced to 1/10.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A peripheral device which is connected to a bus in a host system, and executes wireless communication for transmitting/receiving data between the host system and another system, comprising:
a CPU;
a timer configured to generate an interrupt signal to the CPU every predetermined interval;
a bus controller having a function of generating an interrupt signal to the CPU, configured to control input of transmission data from the host system via the bus and output of reception data to the host system via the bus;
a communication controller configured to receive the transmission data of the host system from the bus controller to transfer the transmission data to the another system, and to receive the reception data of the host system from the another system to transfer the reception data to the bus controller, under the control of the CPU;
a transmission control unit configured to activate the CPU by an interrupt function of the bus controller and to cause the communication controller to transmit the transmission data to the another system, when the bus controller receives the transmission data;
a reception control unit configured to activate the CPU in response to the interrupt signal generated by the timer and to cause the communication controller to periodically receive the reception data of the host system from the another system, the receiving the reception data containing check of presence/absence of the reception data; and
a clock control circuit configured to divide clock supply for the bus controller and to control the clock supply in order to stop the clock supply to a portion for a data reception process in the bus controller in a period of time other than a time for the reception operation performed by the communication controller, while the clock is kept supplied to a portion for a data transmission process in the bus controller.

2. The peripheral device according to claim 1, wherein the CPU instructs the clock control circuit to start the clock supply to a portion for the data reception process in the bus controller, when the reception data of the host system is present as a result of the reception operation performed by the communication controller upon reception of the interrupt signal from the timer.

3. The peripheral device according to claim 2, wherein the CPU instructs the clock control circuit to stop again the clock supply to a portion for the data reception process in the bus controller, when all the reception data have been output to the host system by the bus controller.

4. The peripheral device according to claim 1, wherein the CPU instructs the clock control circuit to stop the clock supply to a portion for the data transmission process in the bus controller, when the host controller notifies the bus controller, via the bus, that no data is transmitted to said another system.

5. The peripheral device according to claim 1, wherein the CPU instructs the clock control circuit to supply the clocks to all portions in the bus controller when activating the peripheral device, and instructs the clock control circuit to stop the clock supply to a portion for a setting process in the bus controller after initial setting.

6. The peripheral device according to claim 1, wherein the CPU stops the communication controller and the CPU, upon completion of the transmission process of the transmission data and the reception process of the reception data.

7. The peripheral device according to claim 1, wherein the clock control circuit including a clock frequency changing unit configured to change a clock frequency to be supplied to the bus controller, and reduces the clock frequency of the clock instructed to be stopped by the CPU.
